(19) United States
(12) Patent Application Publication
(10) Pub. No.: US 2013/0271733 A1
(43) Pub. Date: Oct. 17, 2013

(54) Triple Filters Projector

(71) Applicant: Kuo-Ching CHIANG, New Taipei City (TW)

(72) Inventor: Kuo-Ching CHIANG, New Taipei City (TW)

(21) Appl. No.: 13/859,731

(22) Filed: Apr. 10, 2013

(30) Foreign Application Priority Data
Apr. 12, 2012 (TW) 101113084

(51) Int. Cl. G03B 21/00

(52) U.S. Cl. CPC G03B 21/008
USPC 353/31

(57) ABSTRACT

A triple white light sources and triple filters projector includes a light guiding device; a triple filters formed with a red, green and blue filters set three sides of the light guiding device; a triple white light sources set said three sides of the light guiding device to generate white light beams with sequence, wherein the triple filters located between said triple white light sources and the three sides of the light guiding device, and the white light beams become red, green and blue after passing the triple white light sources; a digital mirror device panel having a plurality of mirror elements each being controlled so as to reflect light fed from said triple white light sources, an image signal being fed into the digital mirror device panel; and lens positioned in the reflected light path from the digital mirror device panel to project image.

### CROSS-REFERENCE TO RELATED APPLICATIONS

This application claims the benefit of TAIWAN patent application No. 101113084, filed Apr. 12, 2012, which are herein incorporated by reference.

### TECHNICAL FIELD

The present invention relates generally to a projecting module and more particularly to a triple filters projecting module for portable device or a stand alone projector.

### BACKGROUND OF RELATED ART

The conventional projector employs DMD (digital micro-mirror device) and a color wheel for projecting. The digital mirror device has several hundreds of thousands of mirror elements and it is capable of reducing a difference in chromaticness (tint) caused by performance/characteristic variation between filters or between light sources. A driving unit controls an inclination of each of mirror elements of a DMD panel according to a corrected video signal and a revolution state of a color filter wheel and wherein the correcting unit corrects luminance signal for each color of video signals.

Further, another conventional technical employs R, G, B light as the light sources, however, the luminous of the R, G, B light sources are too low, therefore, it cannot project a larger scale image or cannot be displayed with a dark room. Secondly, the luminous of the R, G, B are difference with one another to cause it is unlikely to design the light engine.

### SUMMARY

The object of the present invention is to provide triple filters projector with white color light source.

A triple white light sources and triple filters projector includes a light guiding device; a triple filters formed with a red, green and blue filters set three sides of the light guiding device; a triple white light sources set said three sides of the light guiding device to generate white light beams with sequence, wherein the triple filters located between said triple white light sources and the three sides of the light guiding device, and the white light beams become red, green and blue after passing the triple white light sources; a digital mirror device panel having a plurality of mirror elements each being controlled so as to reflect light fed from said triple white light sources, an image signal being fed into the digital mirror device panel; and lens positioned in the reflected light path from the digital mirror device panel to project image. A light-uniformity device is located on the optical path between a reflector and the digital mirror device panel. The switching-on time of any two of the three white lights is overlapped. A sequence light control module is coupled to the triple white light sources for switching to emit white light with sequence. The three white light sources includes organic electroluminescence element, LED, field emitting element, laser or the combination thereof to emit white light. The switching at least two of the white light sources which are set corresponding to the red and said green filter of the triple filters to generate yellow color light within a time interval. The projector is embedded into a portable device including cellular, notebook, GPS, PDA, game player, media player, video camera or still camera. The light guiding device includes X-cube, X-plate or dichroic mirror.

### BRIEF DESCRIPTION OF THE DRAWINGS

FIG. 1 shows a diagram of a projector according to the present invention.

FIG. 2 shows a lens array according to the present invention.

FIG. 3 shows an optical path according to the present invention.

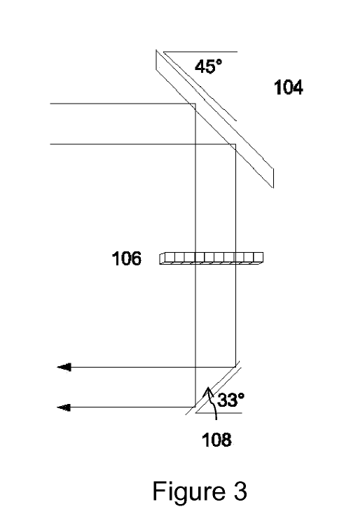

FIG. 4 shows a diagram of projector according to the present invention.

### DETAILED DESCRIPTION

The better implementation of the present disclosure will be described in detail cases and point of view, but such a narrative explanation of the disclosure system structure and process, only to illustrate and not to limit the scope of this invention patent. Therefore, in addition to the description of a better implementation of the cases, the present invention can be implemented widely applied in other cases.

The present invention relates generally to a projecting module for portable terminal or stand alone projector. The portable terminal includes but not limited to cellular phone, PDA (personal digital assistant), smart phone, notebook, medium player (MP3, MP4), GPS and the equivalent thereof.

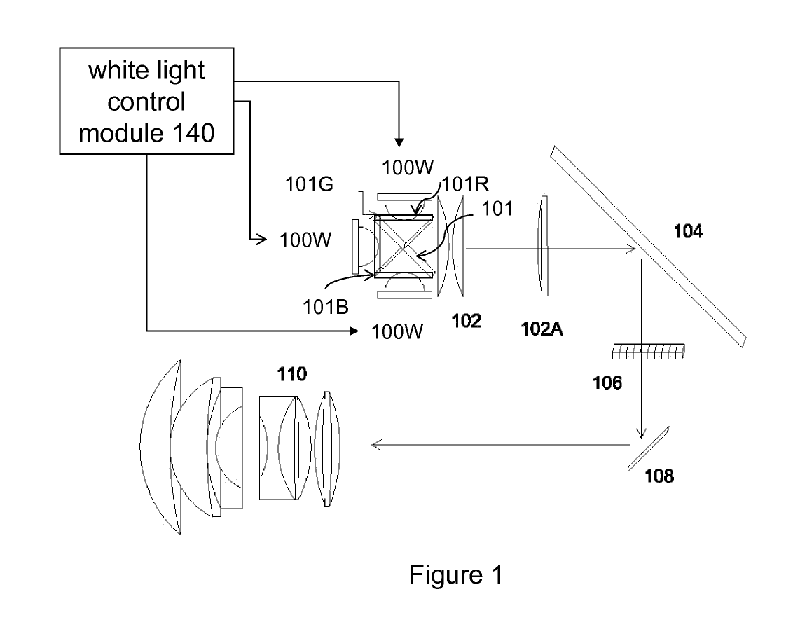

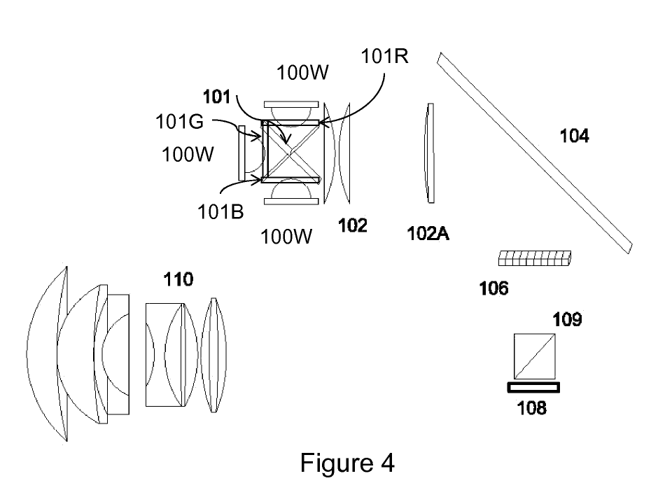

FIGS. 1, 4 are diagrams illustrating main components of triple filters projector using a DMD (Digital Micro-mirror Device) panel according to an embodiment of the present invention. The projector as shown in FIGS. 1 and 4, includes three white light source units 100W, a DMD panel 108, and projection lens 110. Some elements (such as lens amplifier, converter, correcting section and driving section) may be necessary. In one embodiment, lens amplifier may be located between the light source unit 100W and the DMD panel 108. However, they are not the feature of the present invention, thus the description is omitted. In the embodiment, the DMD panel 108 includes a plurality of micro-mirror elements (not shown) and controlled by the driving section. The driving section produces image light to be projected onto the screen and the inclination state of each of the mirror elements (not shown) is according to a switching state of the color light source state. The white light source units 100W may emit white light. A sequence white light control module 140 is coupled to the white light source units 100W to determine which color of light will be emitted. The sequence white light control module 140 is employed to switching the colors and it may be formed by integrated circuits. The switching frequency should be higher than the one of the image signal. The three white light source units are set around a three sides of a X-cube or X mirror 101 which is employed to guide the lights from the three sides and emits the lights from the forth side. Triple filters formed with R, G, B color filters 101R, 101G, 101B are set around three sides of the X-cube or X mirror 101 and between the cube and the light sources. The three white light source will became red, green and blue light after the white light sources pass through the triple filter, respectively. The luminous of the white light is higher than the R, G, B color LED, therefore, the present invention may obtain the higher luminous projection and the control and design is easier due to the white light source may be set as the same. Alternatively, it may be replaced with different power or luminous white light source depending on the necessary.

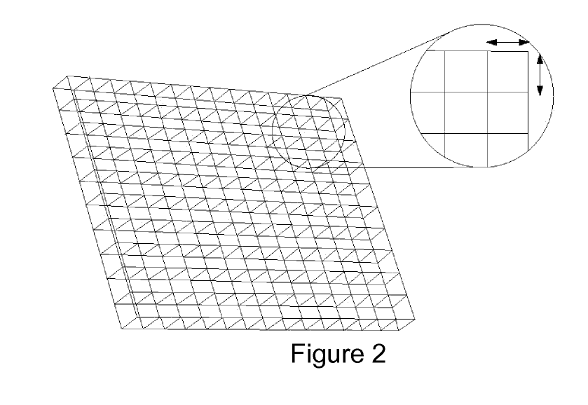

The present invention includes a lens array 106 located between a reflector 104 and the DMD 108 to evenly distribute the light to the DMD 108 as shown in FIG. 2. Preferably, the sequence white light control module 140 make the light source units 100W to emit the white light and they are turned into red, blue and green color light with sequence after the lights pass through the triple filters. The order of the color can be altered. In order increase image brightness, each blue segment may be followed by a white segment, it means the three light sources are turn on at the same time. Alternatively, it may be yellow light segment which is mixed by red and green. It means the white lights corresponding with the read and green filters are on at the same time after the R, G, B segments. The DMD receives an input signal with a gray scale signal used to control an inclination of each of the mirror elements according to a gray scale of each video signal. Thus, each frame of gray scale image will be reflected with the R, G, B (or R, G, B, Y or R, G, B, W) colors one by one. Thus, the switching frequency of the sequence light color control module is higher than the frequency of the video signal. Namely, the frequency of the each color light is at least triple times of the one of the video signal. If four colors are employed, then, the frequency will be four times. The multiple frequency of the color control module will make sure each frame of the image will be processed with R, G, B. The digital mirror device panel having a plurality of mirror elements each being controlled so as to be put in a first inclination state and in a second inclination state and reflecting light fed from the light source unit and switched by the control module while being put in the first inclination state. A driving unit is used to control so as to put each of the mirror elements in the digital mirror device panel in the first inclination state or the second inclination state according to a corresponding video signal and a switching state of the color control unit. A correcting unit is used to receive a video signal and the voltage obtained by photoelectric conversion device, to correct the video signal, based on the received voltage and to output the corrected video signal to the driving unit. The control module 140 is configured to include a red, a green and a blue color light source for making image light of the plurality of colors.

Please be noted that the elements with fluorescent substances (carbon nanotube field emission device if the emitter is formed by carbon nano-tube) and EL can be used as light source as well. Similarly, the light source unit can be formed by three white light FED (or EL) or a FED which may emit lights. Please be note, laser diode maybe used as the light sources. Alternatively, the light source unit may be composed of a laser and a color conversion module posited on the light path of the laser. Preferably, color conversion module may be achieved by an efficient laser wavelength conversion technology, which enables the generation and conversion of new laser wavelengths via material's nonlinearity character. Based on engineered microstructures within ferroelectric nonlinear materials, a quasi-phase-matching (QPM) is generated to compensate the phase-velocity mismatching between interaction waves for efficient wave-mixings. The QPM enables laser-based R, G, B display application.

The each light segment is not overlapped, but in another case, the segments of the color light may be overlapped to increase the photo numbers, thereby increasing the luminous. In one case, the overlap of each two light sources is over fifty percentages. Under such case, at least two kinds of color are emitted at each time interval. The light under switching in such a manner such as that the light has any one of the red, blue, yellow, and green colors by the color control module and travels toward DMD. Since switching of the color light source unit is sufficiently fast, during the persistence of vision, the afterimage is thought to persist on the retina.

FIG. 1 shows the illuminations 100W which includes three white light sources. A sequence white light control module 140 is coupled to the three white light source. A light guiding device is arranged such that three light sources 100W located three sides of the light guiding device independently. The light guiding device is, for instance, X-cube, X-plate or dichroic mirror. The three light sources are switched on in sequence; therefore, the eyes may sense the color image due to phenomenon of vision persistence. Yellow or white lights may be offered to improve the luminous.

If the image signal is indicated by S with an image signal frequency, the turn-on time for each white color light is ⅓ or ¼ of each image frame. After a certain playing time, each color is turn on for only ⅓ or ¼ of the total playing time, thereby achieving the purpose of power saving. In order to increase the photo number within the image frame, the switching frequency (rate) of the R, G, B is raised, in the case, the switching on time is overlapped with another color by 50% for each colors. To phrase in another way, the second color is enable when the first color is switched to half of the switching on cycle. When the first color is off and the third color is on. At any moment, there are two kind of color light is on and the third one is off to increase the luminous.

A light-uniformity device can be provided between the light guiding device and the light sources. The light-uniformity device may be a Fresnel lens which reduces the amount of material required compared to a conventional spherical lens by dividing the lens into a set of concentric annular sections known as “Fresnel zones”. Each zone was actually a separate prism. In each of these zones, the overall thickness of the lens is decreased, effectively dividing the continuous surface of a standard lens into a set of surfaces of the same curvature, with stepwise discontinuities between them.

The present invention may be integrated into a portable device for example, cellular. The projector or the portable device may include a wireless transferring module coupled to the central control unit 100 for transferring data wireless and it maybe employed to transfer data between the hand-held device and an external device such as access point or computer (local or remote terminal) via network. In one embodiment, the wireless transmission module for short range refers to WLAN (wireless local area network) module. As known, the WLAN may transfer data, information between the device and the external device. Thus, the device 10 may employ the wireless transmission module to exchange data.

The present invention omits the independent red, green and blue light sources due to these luminous of the light sources are too low to project high luminous or larger scale image in a bright environment. They can only be displayed with a dark room. In order to solve the issue above, the present employs white light sources which has higher luminous and triple filter to generate R, G, B with higher luminous than the conventional projector.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

I claim:

1. A triple white light sources and triple filters projector comprising:
a light guiding device;
a triple filters formed with a red, green and blue filters set three sides of said light guiding device;
a triple white light sources set said three sides of said light guiding device to generate white light beams with sequence, wherein said triple filters located between said triple white light sources and said three sides of said light guiding device, and said white light beams become red, green and blue after passing said triple white light sources;
a digital mirror device panel having a plurality of mirror elements each being controlled so as to reflect light fed from said triple white light sources, an image signal being fed into said digital mirror device panel; and
lens positioned in the reflected light path from said digital mirror device panel to project image.

2. The projector of claim 1, further comprising light-uniformity device located on said optical path between a reflector and said digital mirror device panel.

3. The projector of claim 1, wherein switching-on time of any two of said three white lights is overlapped.

4. The projector of claim 3, further comprising a sequence light control module coupled to said triple white light sources for switching to emit white light with sequence.

5. The projector of claim 1, wherein said three white light sources includes organic electroluminescence element, LED, field emitting element, laser or the combination thereof to emit white light.

6. The projector of claim 5, further comprising a sequence light control module coupled to said triple white light sources for switching to emit white light with sequence.

7. The projector of claim 1, further comprising switching at least two of said white light sources which are set corresponding to said red and said green filter of said triple filters to generate yellow color light within a time interval.

8. The projector of claim 7, further comprising a sequence light control module coupled to said triple white light sources for switching to emit white light with sequence.

9. The projector of claim 1, further comprising a sequence light control module coupled to said triple white light sources for switching to emit white light with sequence.

10. The projector of claim 9, wherein projector is embedded into a portable device including cellular, notebook, GPS, PDA, game player, media player, video camera or still camera.

11. The projector of claim 9, wherein said light guiding device includes X-cube, X-plate or dichroic mirror.
